(19) United States
(12) Patent Application Publication
(10) Pub. No.: US 2021/0331269 A1
(43) Pub. Date: Oct. 28, 2021

(54) RESISTANCE WELDING CONTROL SYSTEM AND METHOD OF CONTROLLING RESISTANCE WELDING

(71) Applicant: SUBARU CORPORATION, Tokyo (JP)

(72) Inventor: Kenichi KANAI, Tokyo (JP)

(21) Appl. No.: 17/212,889

(22) Filed: Mar. 25, 2021

(30) Foreign Application Priority Data
Apr. 23, 2020 (JP) 2020-076662

(51) Int. Cl. B23K 11/11; B23K 11/25

(52) U.S. Cl. CPC B23K 11/115; B23K 11/258; B23K 11/257

(57) ABSTRACT

A resistance welding control system includes an electrode displacement detector, a temperature estimation information acquiring unit, and a temperature estimation unit. The electrode displacement detector detects a positional displacement between opposite electrodes while the electrodes are supplying electricity between the electrodes to perform resistance welding of welding members held between the electrodes. At least one of the electrodes is movable toward or apart from the other electrode. The temperature estimation information acquiring unit acquires at least an interelectrode voltage, a current density in the welding members, and a physical property value of the welding members as temperature estimation information to be used to estimate a temperature of a welding portion between the welding members. The temperature estimation unit estimates the temperature of the welding portion based on the temperature estimation information and the positional displacement while at least either one of the positional displacement and the interelectrode voltage is stabilized.

### CROSS-REFERENCE TO RELATED APPLICATIONS

The present application claims priority from Japanese Patent Application No. 2020-076662 filed on Apr. 23, 2020, the entire contents of which are hereby incorporated by reference.

### BACKGROUND

The technology relates to a resistance welding control system and a method of controlling resistance welding. For example, the technology relates to a resistance welding control system and a method of controlling resistance welding in which at least one of paired electrodes is moved toward or apart from the other electrode.

Resistance welding, which is advantageous in producing products with less distortion and having an excellent appearance within a short period of time, is widely used in the automobile industry, in particular, the manufacture of vehicle bodies. It is important for the resistance welding to control a pressure applied to members to be welded (hereinafter referred to as welding members) to each other. Known resistance welding, which is so-called spot welding, is achieved by melting welding members by Joule heat generated by a contact resistance between the welding members. The contact resistance varies depending on a pressure applied to the welding members. Moreover, after melting the welding members, the known resistance welding needs to effectively combine the metal atoms of the welding members while a contact portion between the welding members is held under a pressure applied from the electrodes. In many recent resistance welding methods, one of the paired electrodes (also called guns) is moved toward or apart from the other electrode by a motor to apply a pressure to the welding members. For example, the torque of the motor is controlled to apply a constant pressure to the welding members, which is called “servo control”.

An effective way to secure the quality of a welding portion between the members subjected to resistance welding is to measure the temperature of the welding portion. For example, if the temperature of the welding portion is higher than the melting point of the welding members, the welding strength of the welding portion is secured after melting and solidifying. An example method of estimating the temperature of the welding portion is described in Japanese Unexamined Patent Application Publication (JP-A) No. H4-178275, for example. The temperature estimation method involves detecting a welding current and a voltage across the electrodes, calculating a temperature distribution within the welding members from the detected values on the basis of a heat conduction model, detecting the amount of movement of the electrodes after electric supply, and correcting the calculated temperature distribution within the welding members on the basis of an average temperature of the welding members calculated from the amount of movement of the electrodes. For example, the amount of movement of the electrodes after the electric supply is calculated from the rotational angle of the motor driven under the servo control described above. In the method of estimating the temperature of the welding portion, the temperature of the welding members at the start of the electric supply (i.e., the start of welding) is regarded as a room temperature, and the electric resistivity of the welding members at the start of welding is regarded as the electric resistivity at the room temperature, for example. A current path diameter is calculated on the basis of the electric resistivity at the start of welding, a voltage across the electrodes, and a welding current. Using the current path diameter, a time-series temperature distribution within the welding members after the electric supply is calculated on the basis of the heat conduction model.

### SUMMARY

An aspect of the technology provides a resistance welding control system including an electrode displacement detector, a temperature estimation information acquiring unit, and a temperature estimation unit. The electrode displacement detector is configured to detect a positional displacement between opposite electrodes while the opposite electrodes are supplying electricity between the opposite electrodes to perform resistance welding of welding members held between the opposite electrodes. At least one of the opposite electrodes is movable toward or apart from the other electrode. The temperature estimation information acquiring unit is configured to acquire at least a voltage across the opposite electrodes, a current density in the welding members, and a physical property value of the welding members as temperature estimation information to be used to estimate a temperature of a welding portion between the welding members. The temperature estimation unit is configured to estimate the temperature of the welding portion between the welding members on the basis of the temperature estimation information acquired by the temperature estimation information acquiring unit and the positional displacement between the opposite electrodes detected by the electrode displacement detector while at least either one of the positional displacement between the opposite electrodes and the voltage across the opposite electrodes is stabilized.

An aspect of the technology provides a method of controlling resistance welding including: performing an electrode displacement detection process to detect a positional displacement between opposite electrodes while the opposite electrodes are supplying electricity between the opposite electrodes to perform resistance welding of welding members held between the opposite electrodes under a predetermined pressure, at least one of the opposite electrodes being movable toward or apart from the other electrode; performing a temperature estimation information acquiring process to acquire at least a voltage across the opposite electrodes, a current density in the welding members, and a physical property value of the welding members as temperature estimation information to be used to estimate a temperature of a welding portion between the welding members; and performing a temperature estimation process to estimate the temperature of the welding portion between the welding members on the basis of the temperature estimation information acquired by the temperature estimation information acquiring process and the positional displacement between the opposite electrodes detected by the electrode displacement detection process while at least either one of the positional displacement between the opposite electrodes and the voltage across the opposite electrodes is stabilized.

An aspect of the technology provides a resistance welding control system including an electrode displacement detector, and circuitry. The electrode displacement detector is configured to detect a positional displacement between opposite electrodes while the opposite electrodes are supplying electricity between the opposite electrodes to perform resistance welding of welding members held between the opposite electrodes. At least one of the opposite electrodes is movable toward or apart from the other electrode. The circuitry configured to acquire at least a voltage across the opposite electrodes, a current density in the welding members, and a physical property value of the welding members as temperature estimation information to be used to estimate a temperature of a welding portion between the welding members, and estimate the temperature of the welding portion between the welding members on the basis of the acquired temperature estimation information and the positional displacement between the opposite electrodes detected by the electrode displacement detector while at least either one of the positional displacement between the opposite electrodes and the voltage across the opposite electrodes is stabilized.

### BRIEF DESCRIPTION OF THE DRAWINGS

The accompanying drawings are included to provide a further understanding of the technology and are incorporated in and constitute a part of this specification. The drawings illustrate example embodiments and, together with the specification, serve to explain the principles of the technology.

FIG. 1 is a diagram illustrating a schematic configuration of a resistance welding apparatus to which a resistance welding control system and a method of controlling resistance welding according to one example embodiment of the technology are applied.

FIG. 2 is a flowchart illustrating a calculation process executed by a processor illustrated in FIG. 1.

FIG. 3 is an explanatory diagram illustrating a welding portion between welding members.

FIG. 4 is an explanatory chart illustrating a temperature-dependent physical property value of steel.

FIG. 5 is an explanatory diagram illustrating measurement values read by the processor illustrated in FIG. 1.

FIG. 6 is an explanatory chart illustrating an interelectrode voltage model and a head conduction model.

### DETAILED DESCRIPTION

The method of estimating the temperature of the welding portion disclosed in JP-A No. H4-178275 assumes that the temperature distribution within the welding members is calculated in a time-series manner from the start of welding. However, at an initial stage of the electric supply, a change in contact resistance and a rapid change in physical phenomenon can be caused in association with a rapid increase in temperature. To accurately calculate the time-series temperature distribution within the welding members in consideration of these factors, it is necessary to collect precise data and to perform a large number of calculations. Moreover, dust or sputter is likely to generate at the initial stage of the welding, which can hinder the accurate calculation of the time-series temperature distribution. For these reasons, it is practically difficult to achieve the temperature estimation method that involves repeated calculations of the time-series temperature distribution within the welding members from the start of welding in resistance welding for mass production.

It is desirable to provide a resistance welding control system and a method of controlling resistance welding that make it possible to enhance the welding quality by estimating the temperature of a welding portion between welding members even in resistance welding for mass production.

Hereinafter, some example embodiments of a resistance welding control system and a method of controlling resistance welding of the technology are described in detail with reference to the accompanying drawings. Note that the following description is directed to illustrative examples of the technology and not to be construed as limiting to the technology. Factors including, without limitation, numerical values, shapes, materials, components, positions of the components, and how the components are coupled to each other are illustrative only and not to be construed as limiting to the technology. Further, elements in the following example embodiments that are not recited in a most-generic independent claim of the technology are optional and may be provided on an as-needed basis. The drawings are schematic and are not intended to be drawn to scale. Throughout the present specification and the drawings, elements having substantially the same function and configuration are denoted with the same numerals to avoid any redundant description.

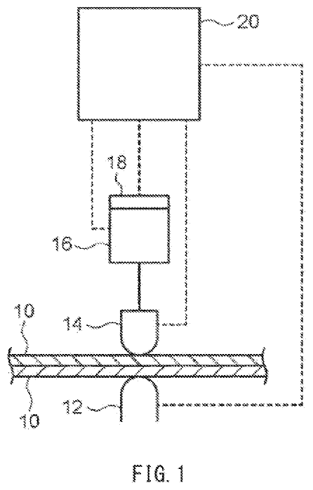

FIG. 1 is a diagram illustrating a schematic configuration of a resistance welding apparatus according to an example embodiment of the technology. The resistance welding apparatus according to the example embodiment may include two plate members to be welded (hereinafter referred to as welding members 10) and paired electrodes (guns) 12 and 14 holding the welding members 10 therebetween under a longitudinal pressure, for example. An electric current may be supplied between the electrodes 12 and 14 holding the welding members 10 therebetween. The welding members 10 held between the electrodes 12 and 14 under pressure may generate a contact resistance at a contact portion, and Joule heat may be generated by the electric supply between the electrodes 12 and 14 at the contact portion having the contact resistance. The welding members 10 may be welded to each other by being melted by the Joule heat and solidified. The contact portion to be melted or solidified is generally referred to as a nugget. Note that the number of the welding members 10 used in the resistance welding apparatus according to the example embodiment should not be limited to two, and that the shape of the welding members 10 should not be limited to a plate shape. The welding members 10 may include the same material or different materials.

In the example embodiment, the electrode 12 illustrated in a lower part of FIG. 1 may be a fixed electrode, whereas the electrode 14 illustrated in an upper part of FIG. 1 may be a movable electrode that is movable toward or apart from the fixed electrode 12. The movable electrode 14 is moved toward or apart from the fixed electrode 12 by a motor 16. The electrodes 12 and 14 supply an electric current to the welding members 10 held therebetween and apply a predetermined pressure to the welding members 10 as described above. In general, the pressure applied to the welding members 10 by the electrodes 12 and 14 is kept constant during the electric supply for resistance welding. In the example embodiment, the pressure applied to the welding members 10 may be kept constant by setting the torque of the motor 16 that drives the movable electrode 14 at a constant value. The control of the driving force of the motor 16 may be so-called servo control.

During the electric supply between the electrodes 12 and 14, the movable electrode 14 may change its position by moving toward or apart from the fixed electrode 12 in association with thermal expansion or thermal contraction of the welding members 10. This displacement may be caused by a constant pressure applied to the welding members 10 under the constant torque control of the motor 16. In this example embodiment, the temperature of the welding portion (also called a joint) between the welding members 10 is estimated using an interelectrode distance between the electrodes 12 and 14 opposed to each other. Note that the interelectrode distance between the electrodes 12 and 14 may correspond to the displacement of the electrode. The interelectrode distance between the electrodes 12 and 14 may be calculated by detecting only the position of the movable electrode 14 because the position of the fixed electrode 12 remains unchanged. The position of the movable electrode 14 may be detected by detecting a rotational position of the motor 16 by an existing encoder (rotational position sensor) 18 that detects the position of a rotor magnetic pole of the motor 16. For another known resistance welding apparatus that includes movable electrodes opposed to each other, the positions of the movable electrodes may be controlled by respective motors. In that case, the interelectrode distance between the opposite electrodes during the electric supply may be calculated from a difference between values detected by respective encoders 18.

The driving force of the motor 16 and the welding current supply between electrodes 12 and 14 may be controlled by a processor 20. The processor 20 may include a computer system with a high calculation capacity. Like a typical computer system, the computer system included in the processor 20 may include a high-performance calculator, a storage that stores programs and data, and an input/output device that receives and outputs information or data. For example, the processor 20 may read a detection signal of the encoder 18, and perform feedback control of the detection signal of the encoder 18 and a driving current to be supplied to the motor 16. The processor 20 may also read a voltage across the electrodes 12 and 14 (hereinafter also referred to as interelectrode voltage) and a current value from non-illustrated various sensors. Alternatively, the processor 20 that executes a calculation process described later may be implemented by incorporating a separate computer system in a resistance welding control apparatus that only controls resistance welding. In one embodiment, the encoder 18 may serve as an “electrode displacement detector”. In one embodiment, the processor 20 may serves as a “temperature estimation data acquiring unit”, a “temperature estimation unit”, and a “welding portion state evaluation unit”.

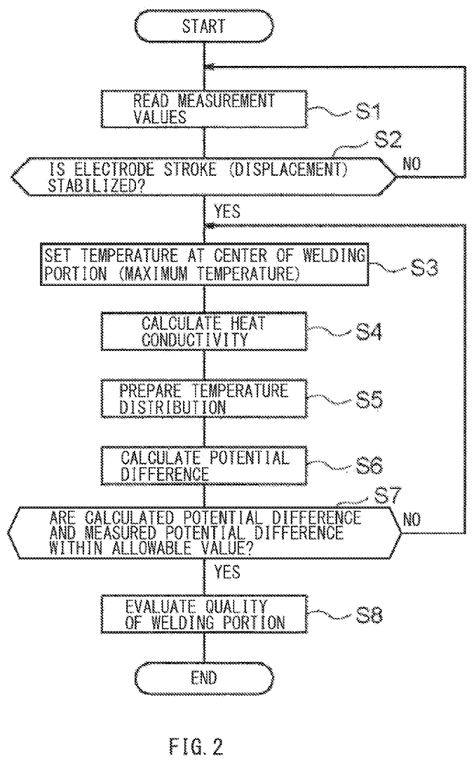

FIG. 2 is a flowchart illustrating the calculation process executed by the processor 20 of the resistance welding control system or in the method of controlling resistance welding according to a first example embodiment. The calculation process may start when resistance welding (e.g., spot welding in the examples illustrated in the drawings) of one welding portion that is achieved by an individual high-order calculation process starts. The calculation process may be repeatedly performed until resistance welding of all welding portions completes. In this calculation process, the temperature of the welding portion between the welding members may be estimated to determine the quality of the welding portion (hereinafter referred to as welding quality). The electric supply between the electrodes 12 and 14 and the driving force of the motor 16 may be controlled through different individual calculation processes. The calculation process may start with Step S1 in which the processor 20 reads measurement values, such as the position of the movable electrode 14, the interelectrode voltage, and the flowing current, as temperature estimation information.

Thereafter, in Step S2, the processor 20 may determine whether an electrode displacement (electrode stroke in the example illustrated in the drawings) is stabilized. If the electrode displacement is stabilized (Step S2: YES), the procedure may proceed to Step S3. If the electrode displacement is not stabilized (Step S2: NO), the procedure may return to Step S1. For example, the processor 20 may read the position of the movable electrode 14 (i.e., interelectrode distance) from the detection signal of the encoder 18, and obtain the amount of change in position of the movable electrode 14 from a previously detected position as the electrode displacement of the movable electrode 14. That is, the electrode displacement may be a displacement (i.e., the amount of movement) of one of the electrodes 12 and 14 with respect to the other of the electrodes 12 and 14 in the direction where the one of the electrodes 12 and 14 is moved toward or apart from the other of the electrodes 12 and 14. The processor 20 may determine that the electrode displacement is stabilized when the calculated electrode displacement is within a predetermined time and a predetermined range. The predetermined range of the electrode displacement may be a predetermined accuracy range in which a maximum temperature of the welding portion, which is described below, is detectable. Note that the processor 20 may determine that the electrode displacement is stabilized even when the electrode displacement is changing within a predetermined angle range.

In Step S3, the processor 20 may set a maximum temperature at the central portion of the welding portion through a method described in detail below.

Thereafter, in Step S4, the processor 20 may calculate heat conductivity of the welding portion between the welding members through a method described in detail below.

Thereafter, in Step S5, the processor 20 may prepare a temperature distribution within the welding portion between the welding members through a method described in detail below.

Thereafter, in Step S6, the processor 20 may calculate a potential difference generated at the welding portion between the welding members through a method described in detail below.

Thereafter, in Step S7, the processor 20 may determine whether the potential difference calculated in Step S6 and a measured potential difference are within an allowable range, i.e., whether the difference between the calculated interelectrode voltage and the measured interelectrode voltage is within an allowable range. If the calculated potential difference and the measured potential difference are within the allowable range (Step S7: YES), the procedure may proceed to Step S8. If the calculated potential difference and the measured potential difference are not within the allowable range (Step S7: NO), the procedure may return to Step S3.

In Step S8, the processor 20 may evaluate the quality of the welding portion. After Step S8, the process may end. For example, the processor 20 may determine that the welding strength and the welding quality are secured when the temperature at the central portion of the welding portion set in Step S3 or the temperature distribution within the welding portion prepared in Step S5 is higher than the melting point of the welding members.

In the calculation process, the maximum temperature of the welding portion may be set while the electrode displacement is stabilized after the start of the electric supply control between the electrodes. The potential difference generated at the welding portion may be calculated from the temperature distribution within the welding portion based on the maximum temperature. If the potential difference is within the allowable range of the measured interelectrode voltage, the welding quality may be evaluated on the basis of the set maximum temperature of the welding portion and the temperature distribution within the welding portion. In contrast, if the potential difference is not within the allowable range of the measured interelectrode voltage, the maximum temperature of the welding portion may be reset, and the potential difference generated at the welding portion may be calculated again on the basis of the temperature distribution based on the reset maximum temperature. That is, in the calculation process, the potential difference generated at the welding portion may be calculated on the basis of the set maximum temperature of the welding portion, and the maximum temperature of the welding portion (and the temperature distribution within the welding portion) may be repeatedly set or calculated until the potential difference falls within the allowable range of the measurement interelectrode voltage.

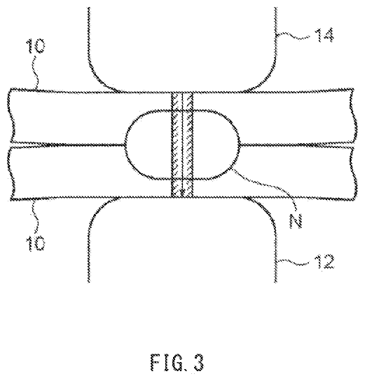

Next, the principal of the calculation process is described. FIG. 3 is a cross-sectional view of the welding portion between the welding members subjected to resistance welding. In this example embodiment, the potential difference or the transfer of heat may be measured in a region surrounded by diagonal lines in FIG. 3. To prevent the region from becoming unclear, hatching in the region is partially omitted in FIG. 3. For example, an oval portion between the welding members 10 held between the electrodes 12 and 14 illustrated in FIG. 3 may correspond to a main portion of the welding portion. The main portion may be called a nugget N. Noted that, however, an actual shape of the nugget N is not necessarily oval. In general, the nugget N is surrounded by a so-called corona bond, which is a ring-shaped solid-phase welded portion, and a heat-affected zone present outside the corona bond. Herein, the welding portion may be a portion having the main portion or the nugget N through which an electric current flows between the electrodes 12 and 14. An analysis of the flowing current demonstrated that the electric current flowing from the movable electrode 14 to the fixed electrode 12, for example, was substantially linear at a central portion of the nugget N of the welding portion. Additionally, a temperature analysis demonstrated that substantially no heat transfer occurred in the lateral direction in FIG. 3 in a relatively small cross-sectional area (the region surrounded by the diagonal lines) passing through the central portion of the nugget N. Hereinafter, the description is made on the region in which an electric current flows in a substantially linear fashion and substantially no lateral heat transfer occurs.

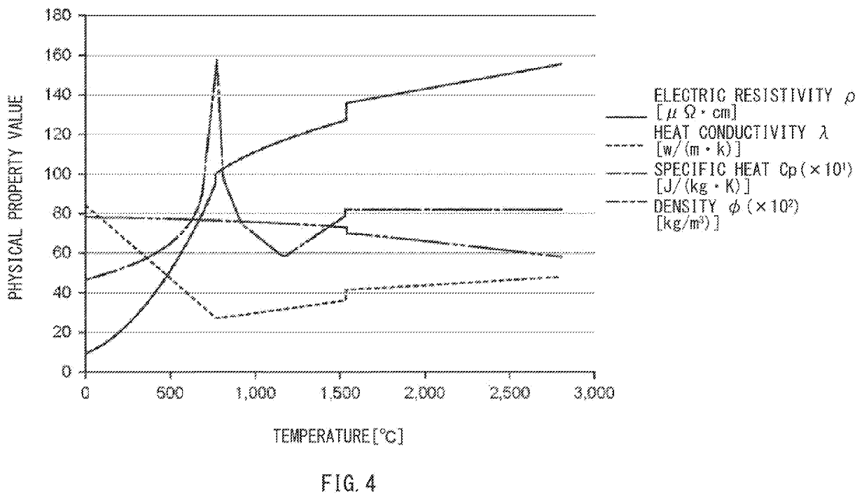

In the following description, physical property values of the welding members 10 may be described. Many of the physical property values described in the example embodiment depend on the temperature of the welding members 10. FIG. 4 illustrates temperature-dependent physical property values of steel, such as an exemplary correlation of electric resistivity ρ, heat conductivity λ, specific heat Cₚ, and density ψ relative to temperature. These temperature-dependent physical property values may be preliminarily stored in a storage of the processor 20. Although the density is represented by a symbol “ρ” in general, the density is represented by a symbol “ψ” herein to differentiate it from the electric resistivity ρ.

Described next is a potential difference V in the region in which substantially no lateral heat transfer occurs and the current flows in a substantially linear fashion. The potential difference V in this region may be represented by the following expression:

V=ρ(T)·j·L Expression 1

where “L” denotes the distance (or length) of the region, “ρ(T)” denotes the function of electric resistivity p of the welding member 10 multiplied by the temperature of T, and “j” denotes a current density obtained by dividing the measured flowing current by the current path diameter that is also described in JP-A No. H4-178275, for example.

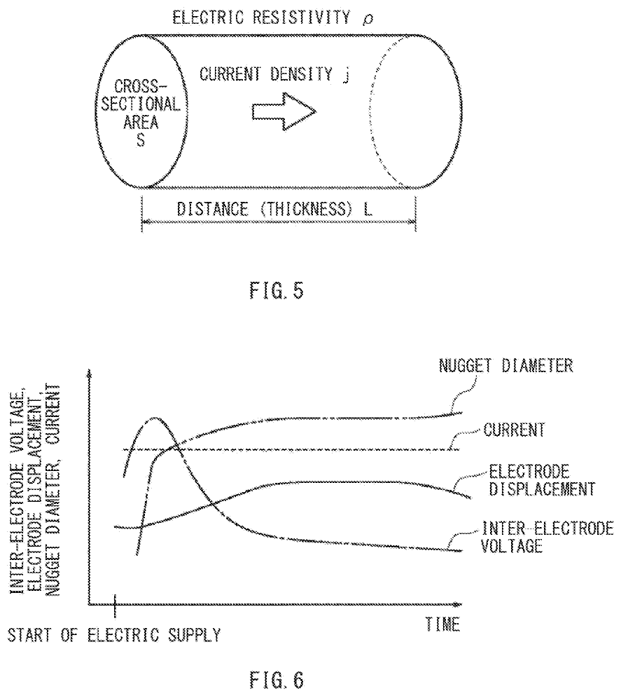

This region may be represented as a cylindrical region as illustrated in FIG. 5, for example. The distance (or length) L between opposite ends of the region may correspond to the distance between the electrodes 12 and 14, i.e., a total thickness of the two welding members 10 in an expanded state. The potential difference V between the opposite ends of the region may be represented by the following expression:

V=∫₀^{L}ρ(x)·jdx=j∫₀^{L}ρ(x)dx Expression 2

where “dx” denotes the length of each small section obtained by dividing the distance L, and “ρ(x)” denotes the function of the electric resistivity ρ in each small section multiplied by a position (displacement) x in the longitudinal direction. The potential difference V between the opposite ends of the region may be obtained by integrating the potential differences in the small sections by the distance L, as represented by Expression 2.

Described next is the heat conductivity of the region in which substantially no lateral heat transfer occurs and the current flows in a substantially linear fashion. The following description assumes that the region is halved into two half regions along its length. The region may be halved into the two half regions at a central portion of the welding portion, i.e., a central portion of the nugget N. The half region extending from the central portion of the nugget N toward the electrode 12 or 14 may exhibit a maximum temperature at the central portion of the nugget N. Because substantially no lateral heat transfer occurs in the region described above, it may be presumed that heat transfers only from the central portion of the nugget N toward either one of the electrodes 12 and 14. That is, heat transfers one-dimensionally in the half regions. In such a case where heat transfers one-dimensionally, a heat conduction equation may be represented by the following expression:

$$φ Cp \frac{\partial T}{\partial t} = \frac{\partial }{\partial x} ( λ \frac{\partial T}{\partial x} ) + w \qquad Expression 3$$

where “ψ” denotes the density of the welding members, “Cₚ” denotes the specific heat of the welding members, “T” denotes the temperature of the welding members, “λ” denotes the heat conductivity of the welding member, “t” denotes time, “x” denotes a position (displacement), and “w” denotes a heat generation amount per unit volume.

Both sides of Expression 3 may be multiplied by “S” which denotes the cross-sectional area of the half region, and “L_{H}” (=L/2) which denotes the length or distance of the half region. Because the amount of heat generation W in the overall half region may be represented by “S×L_{H}×w”, Expression 3 described above may be converted into the following expression:

$$φ {CpSL}_{H} \frac{\partial T}{\partial t} = {SL}_{H} \frac{\partial }{\partial x} ( λ \frac{\partial T}{\partial x} ) + W \qquad Expression 4$$

The left side of Expression 4 may represent a change in temperature per unit time, i.e., the amount of heat or energy consumed in a temperature change in the half region having the cross-sectional area S and the length L_{H} per unit time. The first term of the right side of Expression 4 may represent the heat conductivity in an x-direction (longitudinal direction), i.e., the amount of heat or energy passing through the half region having the cross-sectional area S and the length L_{H} per unit time. The second term of Expression 4 may represent external force, i.e., the amount of heat or energy (Joule heat) generated in the half region having the cross-sectional area S and the length L_{H} per unit time.

FIG. 6 illustrates a temporal change in interelectrode voltage, electrode displacement, and electric current after the start of electric supply. A nugget diameter illustrated in FIG. 6 may be the diameter (average diameter) of the nugget N measured by cutting the resistance-welded member. As described above, a rapid change in physical phenomenon can be caused in association with a rapid increase in temperature at an initial stage of the electric supply as well as a change in contact resistance in association with a rapid change in interelectrode voltage and a rapid increase in nugget diameter. Moreover, dust or sputter is likely to generate at the initial stage of the electric supply. However, the initial stage of the electric supply may include a period of time in which the electrode displacement is stabilized. When the electrode displacement is stabilized, the interelectrode voltage may also be stabilized, which results in a moderate increase in nugget diameter. It may be estimated that the welding portion between the welding members 10 exhibits no or little thermal expansion or no or little thermal contraction while the electrode displacement is stabilized. For example, assuming that the region in which substantially no lateral heat transfer occurs is finely divided into small sections in the longitudinal direction of FIG. 3, the fact that the welding portion between the welding members 10 exhibits no or little thermal expansion or no or little thermal contraction means that no or little temperature change occurs in each small section. Thus, in the example embodiment, the left side of Expression is set at 0 (zero), which means that the electrode displacement is stabilized.

Setting the left side of Expression 4 at 0 (zero), Expression 4 may be further analyzed. First, Joule heat W corresponding to the external force may be represented by the following expression:

W=ρj²SL_{H} Expression 5

where “S” denotes the cross-sectional area of the half region, “L_{H}” denotes the length of the half region, and “j” denotes the current density.

For example, assuming that the half region is obtained by halving the cylindrical region illustrated in FIG. 5, and that heat transfers from the left to the right in the half region, a heat quantity Q₁ at an entry side of the half region and a heat quantity Q₂ at an exit side of the half region may be represented by the following expressions:

$${Q}_{1} = - {λ}_{1} S \frac{\partial T}{\partial x} {\vert}_{x = a} \\ {Q}_{2} = - {λ}_{2} S \frac{\partial T}{\partial x} {\vert}_{x = a + {L}_{H}}$$

where “λ₁” denotes the head conductivity in the left-half area of the half region, and “λ₂” denotes the heat conductivity in the right-half area of the half region.

Because no heat transfer occurs in the lateral direction (in the longitudinal direction in FIG. 5) in the half region, an equitation, Q₁+W=Q₂ may hold. Then, following expression may be obtained by substituting the values described above into the respective terms of the equitation.

$$- {λ}_{1} S \frac{\partial T}{\partial x} {\vert}_{x = a} + ρ {j}^{2} {SL}_{H} = {λ}_{2} S \frac{\partial T}{\partial x} {\vert}_{x = a + {L}_{H}} \qquad Expression 6$$

Then, the following expression may be obtained by moving the term of Expression 6 and dividing both sides of Expression 6 by S×L_{H}.

$$ρ {j}^{2} = - ( {λ}_{2} \frac{\partial T}{\partial x} {\vert}_{x = a + {L}_{H}} - {λ}_{1} \frac{\partial T}{\partial x} {\vert}_{x = a} ) / {L}_{H} \qquad Expression 7$$

As described above, it is assumed that the half region includes the multiple small sections provided in a row. In a case where the length (distance) L_{H} is set to an infinitesimally small value (e.g., L_{H}=0), the heat conductivity in the region may be represented by “λ”, and the following expression may be obtained.

$$ρ {j}^{2} = - \frac{\partial }{\partial x} ( λ \frac{\partial T}{\partial x} ) \qquad Expression 8$$

As in Expression 2 described above, substituting ρ(x), λ(x), and T(x) that are the respective functions of the electric resistivity ρ, the heat conductivity λ, and the temperature T multiplied by the position (displacement) x may yield the following expression.

$${ρ}_{( x )} {j}^{2} = - \frac{\partial }{\partial x} ( {λ}_{( x )} \frac{\partial {T}_{( x )}}{\partial x} ) \qquad Expression 9$$

Then, simultaneous equations of Expressions 2 and 9 may be examined. The potential difference (i.e., interelectrode voltage) V, the current density j, the length (distance) L may be measurement values. The electric resistivity ρ(x) and the heat conductivity λ(x) may be material physical property values simply determined by detecting the temperature T(x) at the position (displacement) x. These temperature-dependent physical property values may be retrieved from the storage. Thus, unknowns in the equations may be the temperature T(x) and the position (displacement) x. There may be only one temperature function T(x) that simultaneously satisfying Expressions 2 and 9 within a range 0≤x≤L. The temperature function T(x) may be analytically determined or calculated by defining a temperature-dependent parameter as an approximate function.

An example way to calculate the temperature function T(x) will now be described. First, the half region may be divided into the small sections having the small distance dx, as described above, for example. Note that the number of the small sections may be limited. In the half region, heat transfers only from the central portion of the nugget N toward the electrode 12 or 14. Thus, the temperature-dependent electric resistivity ρ may be determined by appropriately setting the temperature of the central portion of the nugget N, i.e., the maximum temperature of the nugget N. The small section located at the central portion of the nugget N may have the maximum temperature, and the Joule heat generated in the central small section may all be dissipated to an adjacent small section on the electrode side, as described above. The Joule heat generated in the small section at the central portion of the nugget N may be calculated by replacing the distance L_{H} with the small distance dx of the small section in Expression 5. For example, letting Q denote the Joule heat generated in the small section at the central portion of the nugget N, a temperature gradient ∂T/∂x in the adjacent small section on the electrode side may be calculated by the following expression.

$$Q = - λ S \frac{\partial T}{\partial x} \qquad Expression 10$$

Because the temperature gradient ∂T/∂x in the small section at the central portion of the nugget N is 0 (zero), the temperature change gradient in the small section at the central portion of the nugget N and the adjacent small section on the electrode side may be calculated from an average value between the temperature gradients of the two small sections through the Runge-Kutta method (second-order). Thus, the temperature of the adjacent small section on the electrode side in the central portion of the nugget N may be calculated by adding a multiplied value between the calculated temperature change gradient (negative value) and the distance of the small section (i.e., the small distance dx) to the temperature of the small section at the central portion of the nugget N (i.e., the maximum temperature). Likewise, the heat dissipated from the central small section to the adjacent small section on the electrode side in the nugget N may also be all dissipated to an adjacent small section. Thus, the temperature gradient ∂T/∂x in the two small sections may be obtained. Because the temperature at the adjacent small section on the electrode side in the nugget N has been already obtained, the temperature of each small section may be obtained in sequence toward the electrode. As a result, the temperatures of all of the small sections, i.e., the temperature distribution may be obtained. The calculation process described above may correspond to Step S4 in FIG. 2.

After the temperature of the small sections of the half region is obtained as described above, the temperature-dependent electric resistivity ρ in each small section may be retrieved from the storage. Then, the potential difference between the small sections may be obtained using Expression 2 described above. A total potential difference (integrated value or additional value) of the potential differences between the small sections may correspond to the potential difference generated in the half region, i.e., the potential difference generated in a half distance of the interelectrode distance. Thus, the potential difference in the entire region surrounded by the diagonal lines in FIG. 3 (hereinafter referred to as an entire-region potential difference) may be twice as large as the potential difference in the half region. If the entire-region potential difference is substantially equal to the interelectrode voltage described above, the set maximum temperature at the central portion of the nugget N and the set temperature distribution in each small section may be appropriate.

In contrast, if the entire-region potential difference deviates from the interelectrode voltage, the set maximum temperature at the central portion of the nugget N and the set temperature in each small section (i.e., the temperature distribution in the welding portion) may be inappropriate. Thus, the maximum temperature at the central portion of the nugget N serving as a precondition may be changed and reset (Step S3 of FIG. 2) as described above, and the temperature in each small section may be recalculated to obtain the temperature distribution within the welding portion (Step S5 of FIG. 2). The entire-region potential difference may be obtained by doubling the integrated value (additional value) of the potential differences in the small sections (Step S6 of FIG. 2), and the entire-region potential difference may be compared with the interelectrode voltage (Step S7 of FIG. 2). Note that, in general, the maximum temperature at the central portion of the nugget N and the temperature distribution within each small section increase as the interelectrode voltage increases. Therefore, setting the maximum temperature at the central portion of the nugget N on the basis of the relation allows the temperature distribution to be appropriately obtained through a relatively small number of calculations.

According to the calculation process illustrated in FIG. 2, it is possible to appropriately calculate the maximum temperature at the central portion of the nugget N and the temperature distribution in the welding portion through a relatively small number of calculations. This enables evaluation of the welding quality or welding strength of the welding portion based on the temperature of the welding portion, and inspection of all the resistance welding portions thanks to the small number of calculations or the small calculation load.

According to the resistance welding control system and the method of controlling resistance welding according to the foregoing example embodiments, it may be estimated that, in the period of time in which the displacement of the electrodes 12 and 14 is stabilized after the initial stage of electric supply for resistance welding, the welding portion between the welding members 10 exhibits no or little thermal expansion and no or little thermal contraction, that is, no or little change in temperature may occur in the welding portion between the welding members 10, and that the heat generated by the electric supply is all dissipated by the heat conduction. On the condition that the displacement of the electrodes 12 and 14 has been stabilized and that a temperature change term of the heat conduction model is 0 (zero) or small, the temperature of the welding portion is appropriately calculated through a relatively small number of calculations on the basis of the heat conduction model based on the physical property values of the welding members 10 and the current density-interelectrode voltage model of the welding members 10. Moreover, when the displacement of the electrodes is stabilized after the initial stage of the electric supply, an initial change in contact resistance and a rapid change in physical phenomenon are completed. In such a condition, there is no need to obtain precise temperature estimation information such as the interelectrode voltage, the current density, and the physical property values of the welding members. Additionally, dust is unlikely to generate in such a condition. Thus, it is possible to estimate the temperature of the welding portion between the welding members 10 on the basis of the temperature estimation information at a specific point in time. Accordingly, the resistance welding control system according to the foregoing example embodiments makes it possible to more accurately estimate the temperature of the welding portion between the welding members 10 through a small number of calculations even in resistance welding for mass-production. Such temperature estimation helps enhance the welding quality.

Because the temperature of the welding portion between the welding members is estimated more accurately as described above, the welding strength of the welding portion is secured when the estimated temperature of the welding portion is greater than the melting point of the welding members 10. This helps enhance the welding quality.

Further, under conditions that the displacement of the electrodes 12 and 14 has been stabilized and that the heat generated at the welding portion is to all dissipated by heat conduction, the welding portion exhibits no temperature change. Accordingly, the temperature change term of the heal conduction model based on the physical property values of the welding members 10 may be 0 (zero) or small. Therefore, it is possible to reduce the number of calculations required to calculate the temperature of the welding portion. This allows the temperature at the welding portion to be estimated more accurately.

It should be appreciated that the example embodiments of the resistance welding control system and the method of controlling resistance welding described above are non-limiting examples and may be modified in various ways within the gist of the technology. For example, although the temperature change term of the heat conduction model of the region may be 0 (zero) in the foregoing example embodiments, the temperature of the welding portion may be analytically estimated without removing the temperature change term.

In the foregoing example embodiments, the stabilized state may be determined on the basis of the displacement of the electrodes. Alternatively, the stabilized state may be determined on the basis of the interelectrode voltage. For example, in Step S2 of FIG. 2, the stabilized state may be determined when at least either one of the electrode displacement and the interelectrode voltage is stabilized.

It should be noted that the method of estimating the temperature of the welding portion according to the foregoing example embodiments is a mere example, and the temperature of the welding portion may be estimated by any calculation method other than the method described above.

According to the resistance welding control system of the foregoing example embodiments of the technology, it may be estimated that, in the period of time in which the displacement of the electrodes and/or the interelectrode voltage is stabilized, i.e., the displacement of the electrodes and/or the interelectrode voltage exhibits no or little change after the initial stage of electric supply for resistance welding, the welding portion between the welding members exhibits no or little thermal expansion and no or little thermal contraction, that is, no or little change in temperature may occur in the welding portion between the welding members, and that the heat generated by the electric supply is all dissipated by heat conduction. Under conditions that the displacement of the electrodes and/or the interelectrode voltage has been stabilized and that the temperature change term of the heat conduction model is 0 (zero) or small, the temperature of the welding portion is appropriately calculated through a relatively small number of calculations on the basis of the heat conduction model based on the physical property values of the welding members 10 and the current density-interelectrode voltage model of the welding members 10, for example. Moreover, when the displacement of the electrodes and/or the interelectrode voltage is stabilized after the initial stage of the electric supply, an initial change in contact resistance and a rapid change in physical phenomenon are completed. In such a condition, there is no need to obtain precise temperature estimation information. Additionally, dust is unlikely to generate in such a condition. Thus, it is possible to estimate the temperature of the welding portion between the welding members 10 on the basis of the temperature estimation information at a specific point in time. Accordingly, the resistance welding control system according to the foregoing example embodiments makes it possible to more accurately estimate the temperature of the welding portions between the welding members 10 through a small number of calculations even in resistance welding for mass-production. Such temperature estimation helps enhance the welding quality.

Further, because it is possible for the processor 20 (temperature estimation unit) to more accurately estimate the temperature of the welding portion between the welding members, the welding strength of the welding portion is secured when the estimated temperature of the welding portion is greater than the melting point of the welding members. This helps enhance the welding quality.

Further, under conditions that the heat generated at the welding portion is to all dissipated by heat conduction, the welding portion exhibits no temperature change, and the temperature change term of the heal conduction model based on the physical property values of the welding members 10 may be 0 (zero) or small, for example. Accordingly, it is possible to reduce the number of calculations required to calculate the temperature of the welding portion. This allows the temperature of the welding portion to be estimated more accurately.

According to the method of controlling resistance welding of the foregoing example embodiments of the technology, it may be estimated that, in the period of time in which the displacement of the electrodes and/or the interelectrode voltage is stabilized, i.e., the displacement of the electrodes and/or the interelectrode voltage exhibits no or little change after the initial stage of electric supply for resistance welding, the welding portion between the welding members exhibits no or little thermal expansion and no or little thermal contraction, that is, no or little change in temperature may occur in the welding portion between the welding members, and that the heat generated by the electric supply is all dissipated by heat conduction. Under conditions that the displacement of the electrodes has been stabilized and that the temperature change term of the heat conduction model is 0 (zero) or small, the temperature of the welding portion is appropriately calculated through a relatively small number of calculations on the basis of the heat conduction model based on the physical property value of the welding members 10 and the current density-interelectrode voltage model of the welding members 10, for example. Moreover, when the displacement of the electrodes and/or the interelectrode voltage is stabilized after the initial stage of the electric supply, an initial change in contact resistance and a rapid change in physical phenomenon are completed. In such a condition, there is no need to obtain precise temperature estimation information. Additionally, dust is unlikely to generate in such a condition. Thus, it is possible to estimate the temperature of the welding portion between the welding members 10 on the basis of the temperature estimation information at a specific point in time. Accordingly, the resistance welding control system according to the foregoing example embodiments makes it possible to more accurately estimate the temperature of the welding portions between the welding members 10 through a small number of calculations even in resistance welding for mass-production. Such temperature estimation helps enhance the welding quality.

Further, because it is possible for the processor 20 (temperature estimation unit) to more accurately estimate the temperature of the welding portion between the welding members, the welding strength of the welding portion is secured when the estimated temperature of the welding portion is greater than the melting point of the welding members. This helps enhance the welding quality.

According to the foregoing example embodiments described above, it is possible to more accurately estimate the temperature of the welding portion between the welding members through a small number of calculations even in resistance welding for mass production. This temperature estimation helps enhance the welding quality and enables inspection of all the resistance welding portions.

Some example embodiments of the technology are described in detail above with reference to the accompanying drawings. It should be appreciated that the example embodiments of the technology described above are mere examples and are not intended to limit the scope of the technology. It should be also appreciated that various omissions, replacements, and modifications may be made in the foregoing example embodiments described herein, without departing from the scope of the technology. The technology is intended to include such modifications and alterations in so far as they fall within the scope of the appended claims or the equivalents thereof.

The processor 20 in the resistance welding apparatus illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the processor 20. Such a medium may take many forms, including, but not limited to, any type of magnetic medium such as a hard disk, any type of optical medium such as a CD and a DVD, any type of semiconductor memory (i.e., semiconductor circuit) such as a volatile memory and a nonvolatile memory. The volatile memory may include a DRAM and a SRAM, and the nonvolatile memory may include a ROM and an NVRAM. The ASIC is an integrated circuit (IC) customized to perform, and the FPGA is an integrated circuit designed to be configured after manufacturing in order to perform, all or a part of the functions of the processor 20 in the resistance welding apparatus illustrated in FIG. 1.

1. A resistance welding control system comprising:
an electrode displacement detector configured to detect a positional displacement between opposite electrodes while the opposite electrodes are supplying electricity between the opposite electrodes to perform resistance welding of welding members held between the opposite electrodes, at least one of the opposite electrodes being movable toward or apart from the other electrode;
a temperature estimation information acquiring unit configured to acquire at least a voltage across the opposite electrodes, a current density in the welding members, and a physical property value of the welding members as temperature estimation information to be used to estimate a temperature of a welding portion between the welding members; and
a temperature estimation unit configured to estimate the temperature of the welding portion between the welding members on a basis of the temperature estimation information acquired by the temperature estimation information acquiring unit and the positional displacement between the opposite electrodes detected by the electrode displacement detector while at least either one of the positional displacement between the opposite electrodes and the voltage across the opposite electrodes is stabilized.

2. The resistance welding control system according to claim 1, wherein the welding members are held between the opposite electrodes under a predetermined pressure.

3. The resistance welding control system according to claim 1, further comprising a welding portion state evaluation unit configured to evaluate a state of the welding portion on a basis of the temperature of the welding portion between the welding members estimated by the temperature estimation unit.

4. The resistance welding control system according to claim 2, further comprising a welding portion state evaluation unit configured to evaluate a state of the welding portion on a basis of the temperature of the welding portion between the welding members estimated by the temperature estimation unit.

5. The resistance welding control system according to claim 1, wherein the temperature estimation unit is configured to estimate the temperature of the welding portion on a condition that at least either one of the positional displacement between the opposite electrodes and the voltage across the opposite electrodes has been stabilized and that heat generated at the welding portion between the welding members is to all dissipated by heat conduction.

6. The resistance welding control system according to claim 2, wherein the temperature estimation unit is configured to estimate the temperature of the welding portion on a condition that at least either one of the positional displacement between the opposite electrodes and the voltage across the opposite electrodes has been stabilized and that heat generated at the welding portion between the welding members is to all dissipated by heat conduction.

7. The resistance welding control system according to claim 3, wherein the temperature estimation unit is configured to estimate the temperature of the welding portion on a condition that at least either one of the positional displacement between the opposite electrodes and the voltage across the opposite electrodes has been stabilized and that heat generated at the welding portion between the welding members is to all dissipated by heat conduction.

8. The resistance welding control system according to claim 4, wherein the temperature estimation unit is configured to estimate the temperature of the welding portion on a condition that at least either one of the positional displacement between the opposite electrodes and the voltage across the opposite electrodes has been stabilized and that heat generated at the welding portion between the welding members is to all dissipated by heat conduction.

9. A method of controlling resistance welding comprising:
performing an electrode displacement detection process to detect a positional displacement between opposite electrodes while the opposite electrodes are supplying electricity between the opposite electrodes to perform resistance welding of welding members held between the opposite electrodes under a predetermined pressure, at least one of the opposite electrodes being movable toward or apart from the other electrode;
performing a temperature estimation information acquiring process to acquire at least a voltage across the opposite electrodes, a current density in the welding members, and a physical property value of the welding members as temperature estimation information to be used to estimate a temperature of a welding portion between the welding members; and
performing a temperature estimation process to estimate the temperature of the welding portion between the welding members on a basis of the temperature estimation information acquired by the temperature estimation information acquiring process and the positional displacement between the opposite electrodes detected by the electrode displacement detection process while at least either one of the positional displacement between the opposite electrodes and the voltage across the opposite electrodes is stabilized.

10. A resistance welding control system comprising:
an electrode displacement detector configured to detect a positional displacement between opposite electrodes while the opposite electrodes are supplying electricity between the opposite electrodes to perform resistance welding of welding members held between the opposite electrodes, at least one of the opposite electrodes being movable toward or apart from the other electrode; and
circuitry configured to
acquire at least a voltage across the opposite electrodes, a current density in the welding members, and a physical property value of the welding members as temperature estimation information to be used to estimate a temperature of a welding portion between the welding members, and
estimate the temperature of the welding portion between the welding members on a basis of the acquired temperature estimation information and the positional displacement between the opposite electrodes detected by the electrode displacement detector while at least either one of the positional displacement between the opposite electrodes and the voltage across the opposite electrodes is stabilized.
